(19) United States
(12) Patent Application Publication
(10) Pub. No.: US 2026/0312224 A1
(43) Pub. Date: Oct. 8, 2026

(54) UNDERBODY PROTECTION WITH FUSIBLE SUPPORT STRUCTURES FOR A TRACTION BATTERY AND USE OF FUSIBLE SUPPORT STRUCTURES IN A CAVITY OF AN UNDERBODY PROTECTION

(71) Applicant: Dr. Ing. h.c. F. Porsche Aktiengesellschaft, Stuttgart (DE)

(72) Inventors: Elaheh MURAL, Ölbronn Dürrn (DE); Markus HORNY, Alfdorf-Burgholz (DE); Salvatore MALTISOTTO, Gäufelden (DE)

(21) Appl. No.: 19/636,948

(22) Filed: Apr. 2, 2026

(30) Foreign Application Priority Data
Apr. 3, 2025 (DE) 10 2025 113 007.8

(51) Int. Cl. H01M 50/375; B60K 1/04; B60L 50/64; H01M 50/204; H01M 50/242; H01M 50/249; H01M 50/271

(52) U.S. Cl. CPC H01M 50/375; B60K 1/04; B60L 50/64; H01M 50/204; H01M 50/242; H01M 50/249; H01M 50/271; B60K 2001/0438; H01M 2220/20

(57) ABSTRACT

An underbody protection for a traction battery includes: a protection plate; a lid, which rests on the protection plate and together with the protection plate defines a cavity, including inlet openings arranged in the lid; and support structures arranged in the cavity that are made of a material having a melting point that is configured to melt upon contact with hot gas escaping from a battery cell undergoing thermal runaway of the traction battery arranged above the underbody protection. A volume of the cavity is increased based on the support structures melting.

### CROSS REFERENCE TO RELATED APPLICATIONS

This application claims benefit to German Patent Application No. DE 10 2025 113 007.8, filed on Apr. 3, 2025, which is hereby incorporated by reference herein.

### FIELD

The present disclosure relates to an underbody protection having fusible support structures for a traction battery of an electric vehicle. The present disclosure further relates to the use of fusible support structures in a cavity of an underbody protection.

### BACKGROUND

In electric vehicles, synchronous or asynchronous machines are used as drive motors instead of internal combustion engines. The energy required for this is provided by traction batteries, which are typically arranged in the vehicle floor between the axles due to their size and weight. In order to meet the requirements of the underbody protection (UFS), the traction battery must be physically protected from hazards from below. At the same time, in the load case of thermal runaway, with or without resulting thermal propagation, the underbody protection is intended to serve as a degassing path. A conflict of objectives arises between the mechanical design of the UFS, which should be as stiff as possible with regard to underbody load cases, but should be as soft as possible with regard to the thermal load case.

In accordance with the prior art, the UFS is designed as a stiff plate with integrated supports to accommodate the underbody load cases. The thermal load case is not considered in the design of the UFS.

For example, publication DE 10 2022 104 178 A1 discloses a drive battery for a motor vehicle with a drive battery housing comprising a bottom wall and a lid wall and housing battery cells, and a battery cell contacting system, wherein a support layer for protecting the battery cell layer during a collision of the bottom wall is arranged between the battery cell layer and the bottom wall. The support layer is configured as a carrier for the battery cell contacting system.

Publication DE 10 2021 123 314 A1 discloses an electric vehicle having an electric drive unit, an underbody battery, an underbody protection plate (40) arranged on an underside of the battery housing of the underbody battery, and a degassing device comprising at least one degassing channel. The degassing channel, which is fluidly connectable to the interior of the battery housing and to the external environment, is arranged between the bottom of the battery housing and the underbody protection plate, wherein the degassing channel is bounded by the bottom of the battery housing and the underbody protection plate.

### SUMMARY

In an embodiment, the present disclosure provides an underbody protection for a traction battery. The underbody protection includes: a protection plate; a lid, which rests on the protection plate and together with the protection plate defines a cavity, including inlet openings arranged in the lid; and support structures arranged in the cavity that are made of a material having a melting point that is configured to melt upon contact with hot gas escaping from a battery cell undergoing thermal runaway of the traction battery arranged above the underbody protection. A volume of the cavity is increased based on the support structures melting.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1A shows an exemplary embodiment of the underbody protection according to the present disclosure in a first phase of a thermal load case.

FIG. 1B shows an exemplary embodiment of the underbody protection according to the present disclosure in a second phase of a thermal load case.

FIG. 2 shows a further exemplary embodiment of the underbody protection according to the present disclosure.

### DETAILED DESCRIPTION

Embodiments of the present disclosure provide an underbody protection that at least partially resolve a conflict of objectives of physically protecting the traction battery from hazards from below and serving as a degassing path.

According to an embodiment of the present disclosure, an underbody protection for a traction battery is provided, which substantially comprises a protection plate and a lid, which rests on the protective plate and together with it defines a cavity, wherein inlet openings are arranged in the lid. The underbody protection is designed for arrangement in a vehicle floor, wherein it is arranged directly below the traction battery. In particular embodiments, the underbody protection may abut the traction battery from below. The cavity herein denotes a volume that is formed, as it were, within the double-walled underbody protection.

Support structures are arranged in the cavity and are made of a material having a melting point chosen such that it melts upon contact with hot gas escaping from a battery cell undergoing thermal runaway of the traction battery arranged above the underbody protection, thereby increasing the volume of the cavity. The hot gas flows through openings in the housing of the traction battery and subsequently through the inlet openings in the lid of the underbody protection into the latter. In this respect, the material of the support structures is selected in terms of its temperature resistance such that it melts upon contact with the hot gas and thus releases a degassing volume that was either previously not accessible or was spatially occupied by the at least one support structure. The material of the support structures may have a melting point of approximately 160°C or less, preferably 140°C or less, still further preferably 120°C or less.

Typically, the underbody protection comprises an arrangement of fiber-reinforced plastics (FRP), between which a foam core of, for example, polyurethane is arranged. The arrangement typically has a thickness of between 9 mm and 20.5 mm, of which 1 mm each is occupied at the top and bottom by the thickness of the FRP layers.

In an embodiment of the present disclosure, the foam core providing the integrated support structures can be omitted from the FRP sandwich according to the prior art. According to an embodiment of the present disclosure, the support structures are replaced by thermally unstable but mechanically effective support structures. In the mechanical load case (underbody load case), forces are absorbed and dissipated by the support structures. In the thermal load case, the support structures melt away and release degassing volume. By using the support structures inside the underbody protection, the conflict of objectives of physically protecting the traction battery from hazards from below and serving as a degassing path can be resolved with only one component, so that the requirements of both load cases can be met.

According to further embodiments of the underbody protection according to the present disclosure, the lid can be joined to the protection plate in an airtight manner at the edge. Thus, the cavity (outside the inlet openings) can be made airtight relative to its environment. The joining may be carried out by means of adhesive or a weld seam.

According to further embodiments of the underbody protection according to the present disclosure, the protection plate can be formed in a tray-like shape. In other words, the side walls of the protection plate may be bent upward at their edges and form a rim that is raised relative to the bottom of the protection plate.

According to further embodiments of the underbody protection according to the present disclosure, the support structures can be formed as circumferentially closed structures around the inlet openings. Thus, the support structures can each delimit a small cavity in their interior relative to the remaining cavity.

According to further embodiments of the underbody protection according to the present disclosure, the support structures can comprise or consist of a plastic foam, preferably expanded polypropylene.

According to an embodiment of the present disclosure, there is further provided an electric vehicle comprising a traction battery comprising a battery housing in which a plurality of battery cells are arranged, wherein outgassing openings are arranged in a bottom of the battery housing, and an underbody protection according to any one of the preceding embodiments. The inlet openings arranged in the lid are in connection with the outgassing openings of the battery housing. As a result, the hot gas escaping from a battery cell undergoing thermal runaway during a thermal event may flow from the battery housing into the underbody protection through the inlet openings.

The support structures may be arranged within the underbody protection below the battery cells. For relatively large battery cells, the base area of the support structures in plan view may be the same as or larger than the base area of the battery cells.

According to an embodiment of the present disclosure, the use of fusible support structures is provided in a cavity between a protection plate and a lid of an underbody protection for a traction battery, wherein the support structures are formed from a material having a melting point chosen such that it melts upon contact with hot gas escaping from a battery cell undergoing thermal runway, thereby increasing the volume of the cavity.

The aforementioned features and the features yet to be explained in the following can be used not only in the respectively specified combination, but also in other combinations or on their own, without leaving the scope of the present disclosure.

Additional advantages and configurations of the present disclosure emerge from the following description of the example embodiments and the drawings.

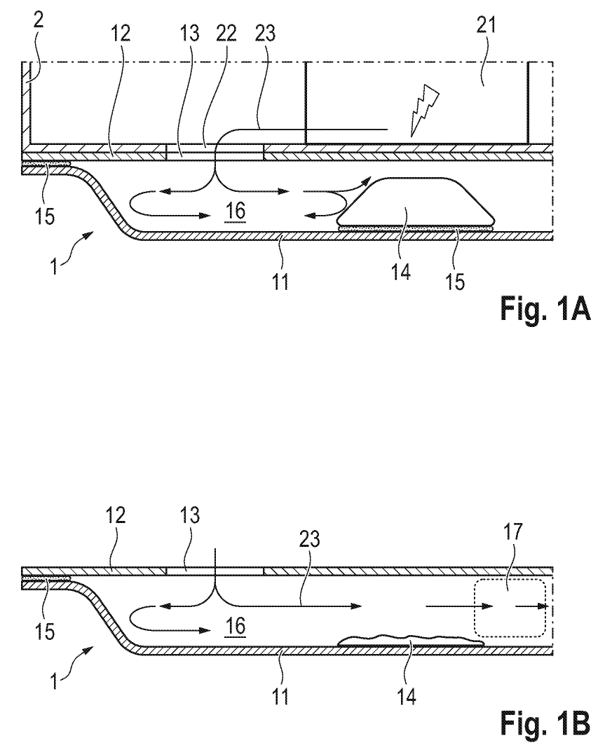

In FIG. 1A, an exemplary embodiment of the underbody protection 1 according to the present disclosure for a traction battery 2 is shown. The underbody protection 1 is shown here together with the traction battery 2, which is embodied by a housing in which battery cells 21 are arranged (one is shown in FIG. 1A). The housing of the traction battery 2 abuts the underbody protection 1.

The underbody protection 1 comprises a protection plate 11 and a lid 12, which rests on the protection plate 11 and together with it defines a cavity 16. The protection plate 11 represents the lower part of the underbody protection 1 facing the roadway in the installed state, while the lid 12, which is airtightly joined at the edges to the protection plate 11, corresponds to the upper part facing the housing of the traction battery 2. In the example shown, the lid 12 is joined to the protection plate 11 by means of an adhesive layer 15. Inlet openings 13 are provided in the lid 12 (one inlet opening 13 shown in FIG. 1). Support structures 14 are arranged in the cavity 16 formed between the lid 12 and the protection plate 11, which increase the mechanical stability of the underbody protection 1. The support structures 14 can also be attached to the inner side of the protection plate 11 with an adhesive layer 15.

The battery cell 21 shown in the housing of the traction battery 2 is a damaged battery cell 21 (indicated by a lightning symbol) that is affected by a thermal event. A hot gas 23 emerges from the battery cell 21, which spreads in the battery housing and also flows through an outgassing opening 22 arranged in the bottom of the housing. The inlet opening 13 arranged in the lid 12 is arranged immediately below the outgassing opening 22 of the battery housing, so that the hot gas 23 can flow into the cavity 16. In the first phase of the thermal load case, in the exemplary embodiment shown, the hot gas 23 is initially contained in a reduced volume within the cavity 16, which is partly bounded by the support structure 14.

The support structures 14 are made of a material having a melting point chosen such that it melts upon contact with hot gas 23 escaping from a battery cell 21 undergoing thermal runaway of the traction battery 2 arranged above the underbody protection 11, thereby increasing the volume of the cavity 16. This second phase of the thermal load case is shown in FIG. 1B, where a traction battery 2 abuts from above. Here, the support structure 14 has melted due to contact with the hot gas 23, so that the volume originally occupied by it has been freed and can be occupied by the hot gas 23. At the same time, in the exemplary embodiment shown, the hot gas 23 can flow into an additional degassing volume 17, which was not available prior to the melting of the support structure 14. For this purpose, the support structures 14 can divide the cavity 16 into mutually gas-tight subareas. Due to the deliberately selected low temperature resistance of the material of the support structures 14 relative to the other components of the underbody protection 1, they are at least partially “broken down” in the thermal load case, and the underbody protection 1 is, as it were, dynamically adapted for optimal handling of the thermal load case.

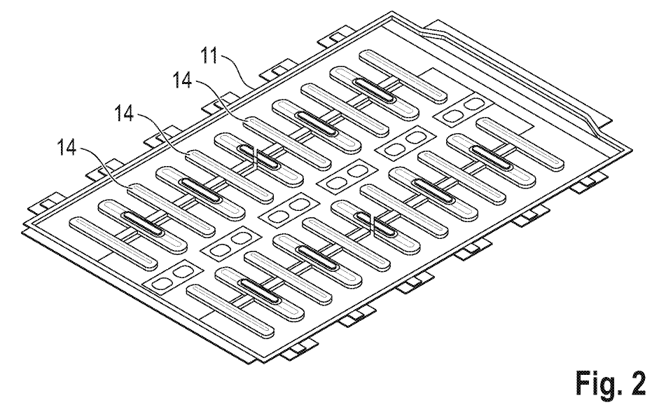

FIG. 2 shows a further exemplary embodiment of the underbody protection according to the present disclosure. The specific design example is shown in an open state without a lid, so that the inside of the protection plate 11 is visible. The support structures 14 are designed in the form of elongated structures.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An underbody protection for a traction battery, comprising:
a protection plate;
a lid, which rests on the protection plate and together with the protection plate defines a cavity, comprising inlet openings arranged in the lid; and
support structures arranged in the cavity that are made of a material having a melting point that is configured to melt upon contact with hot gas escaping from a battery cell undergoing thermal runaway of the traction battery arranged above the underbody protection,
wherein a volume of the cavity is increased based on the support structures melting.

2. The underbody protection according to claim 1, wherein the lid is airtightly joined to the protection plate at an edge.

3. The underbody protection according to claim 1, wherein the protection plate is configured as a tray.

4. The underbody protection according to claim 1, wherein the support structures are formed as circumferentially closed structures around the inlet openings.

5. The underbody protection according to claim 1, wherein the support structures comprise a plastic foam.

6. The underbody protection according to claim 5, wherein the plastic foam comprises expanded polypropylene.

7. The underbody protection according to claim 1, wherein the support structures consist of a plastic foam.

8. An electric vehicle comprising:
a traction battery comprising a battery housing, in which a plurality of battery cells are arranged, and outgassing openings arranged in a bottom of the battery housing; and
the underbody protection according to claim 1, wherein the inlet openings arranged in the lid are in connection with the outgassing openings of the battery housing.

9. A method for protecting a traction battery using an underbody protection, the method comprising:
arranging a fusible support structure in a cavity between a protection plate and a lid of the underbody protection; and
increasing a volume of the cavity based on a material of the fusible support structure melting upon contacting hot gas escaping from a battery cell undergoing thermal runaway of the traction battery.
